(19) United States
(12) Patent Application Publication
(10) Pub. No.: US 2014/0067455 A1
(43) Pub. Date: Mar. 6, 2014

(54) METHOD AND APPARATUS FOR AUTOMATICALLY MANAGING USER ACTIVITIES USING CONTEXTUAL INFORMATION

(71) Applicants: Rui Zhang, San Francisco, CA (US); Oliver Brdiczka, Mountain View, CA (US); Victoria M. E. Bellotti, San Francisco, CA (US); Jianqiang Shen, Santa Clara, CA (US)

(72) Inventors: Rui Zhang, San Francisco, CA (US); Oliver Brdiczka, Mountain View, CA (US); Victoria M. E. Bellotti, San Francisco, CA (US); Jianqiang Shen, Santa Clara, CA (US)

(73) Assignee: PALO ALTO RESEARCH CENTER INCORPORATED, Palo Alto, CA (US)

(21) Appl. No.: 13/599,750

(22) Filed: Aug. 30, 2012

(51) Int. Cl. G06Q 10/10

(52) U.S. Cl. 705/7.24

(57) ABSTRACT

An automatic calendar-managing system automatically updates a user's schedule in response to schedule-modifying events. During operation, the system can detect a schedule-modifying event, which can include an event that is likely to require the user to modify a set of scheduled activities. The system then generates a schedule modification, which includes at least one change to the user's set of scheduled activities, to account for the schedule-modifying event. The system can reschedule the user's set of scheduled activities to accommodate the schedule modification.

### BACKGROUND

1. Field

This disclosure is generally related to calendar systems. More specifically, this disclosure is related to a calendar system that automatically updates a user's schedule.

2. Related Art

Advances in portable computing technologies have made it easier for people to manage their schedules while on the go. People oftentimes carry a portable device with them at all times, such as a smartphone, tablet computer, or laptop computer, which allows them to receive and respond to urgent phone calls or messages that require their sudden attention. These portable devices also include applications that allow users to manually manage their tasks and calendar events, and to share these tasks and events with others. As a user progresses through his day, these applications can remind the user of the tasks and calendar events that the user has pending, and allow the user to manually adjust his schedule as necessary.

However, managing a calendar and task list can itself be a daunting task that requires a significant amount of forethought and attention from the user. Not only does the user need to remember to create calendar entries for the tasks and events that require his attention in the near future, but he also needs to spend significant effort in deciding how to reschedule the tasks or events that he has overlooked or purposely missed.

Oftentimes, the user's schedule can change suddenly as new tasks require his attention, and as other tasks are cancelled or postponed. If the user's schedule is busy, the user may need to spend too much time adjusting his schedule to accommodate each urgent task that needs his attention, or to optimize his schedule after tasks or events are removed. Therefore, instead of adjusting his calendar to reflect each change in his schedule, the user is likely to let his schedule become outdated as new tasks are not added to the calendar and missed tasks and events are not rescheduled. To make matters worse, the user may forget to re-visit older calendar tasks that the user has failed to complete until the task itself becomes an urgent task.

### SUMMARY

One embodiment provides a system that automatically updates a user's schedule. During operation, the system can detect a schedule-modifying event for a user, such as an event which is likely to require the user to modify a set of scheduled activities. The system then generates a schedule modification, which includes at least one change the user's set of scheduled activities, to account for the schedule-modifying event. The system can also reschedule the user's set of scheduled activities to accommodate the schedule modification.

In some embodiments, a scheduled activity includes at least one of a location; a set of participants; an importance score; a time range; and activity-related information.

In some embodiments, the activity-related information includes at least one of: location-related information; transportation information; a coupon; an advertisement; an item list indicating items for the user to bring to the scheduled activity; an electronic document related to the scheduled activity; information about other participants of the scheduled activity; and itinerary-related information for the scheduled activity.

In some embodiments, the system can generate the schedule modification by deriving a new scheduled activity for the user, rescheduling an existing scheduled activity, adding a participant to an existing scheduled activity, removing a participant from an existing scheduled activity, modifying a location for an existing scheduled activity, and/or modifying activity-related information associated with a scheduled activity.

In some embodiments, while generating the schedule modification, the system automatically derives an activity for the user based on historical information associated with the user.

In some embodiments, while generating the schedule modification, the system compares the schedule-modifying event to historical events associated with the user to identify one or more matching historical events. The system then determines, from the matching historical events, one or more target activities that the user has created or modified in response to the historical events. The system creates a scheduled activity based on the one or more target activities.

In some embodiments, the target activity includes an activity that is periodically repeated by the user, and that is not in the user's set of scheduled activities.

In some embodiments, the target activity includes an activity that is historically correlated to an activity in the user's set of scheduled activities (e.g., the user performs the target activity at around the time the user also performs an activity that is similar to one of the user's scheduled activities), and/or an activity that the user performs after one or more activities in the user's set of scheduled activities (e.g., the user performs the target activity after or in response to performing an activity that is similar to one of the user's scheduled activities).

In some embodiments, while rescheduling the set of scheduled activities, the system generates one or more alternative schedules by processing the set of scheduled activities using one or more scheduling techniques. The system then processes a respective schedule using a utility function to compute a utility score for the respective schedule. The system selects, from the alternative schedules, a schedule with a highest utility score.

In some variations, the utility function takes as input one or more of: a priority level or importance score for a respective scheduled activity; a time gap between scheduled activities; a time duration during the scheduled activities; a distance travelled between scheduled activities; and a travel time duration between scheduled activities.

In some variations, the utility function takes as input one or more of: a cost associated with rescheduling a scheduled activity; an activity deadline; a cost for missing a deadline for a scheduled activity; and a scheduling dependency between two or more scheduled activities.

In some embodiments, in response to generating the schedule modification, the system presents the schedule modification to the user, and receives a response to the schedule modification from the user. The system then updates the schedule modification based on the response. The system can also store a historical event that includes the schedule-modifying event in association with the updated schedule modification.

In some embodiments, the system detects the schedule-modifying event in response to determining that the user is traveling to a predetermined location, determining that the user has arrived at a predetermined location, detecting a change in a weather forecast, detecting a change in travel conditions (e.g., road traffic conditions, a roadwork zone, a road closure, a train schedule, a flight schedule, etc.), and/or detecting that a proximity between the user and another participant of a scheduled activity is within a threshold proximity.

In some embodiments, the system detects the schedule-modifying event in response to determining that the user has missed a scheduled activity, and/or determining that a new scheduled activity associated with the user has been created, modified, or cancelled.

In some embodiments, the system detects the schedule-modifying event in response to determining that the user has performed an action that oftentimes precedes the user creating anew scheduled activity, and/or in response to automatically deriving anew activity for the user based on the user's historical activities and preferences.

### BRIEF DESCRIPTION OF THE FIGURES

FIG. 1 illustrates an exemplary computer system that facilitates automatically updating an activity schedule for a user in accordance with an embodiment.

FIG. 2 presents a flow chart illustrating a method for rescheduling a user's activities in accordance with an embodiment.

FIG. 3 presents a flow chart illustrating a method for generating a recommended modification to the user's schedule in accordance with an embodiment.

FIG. 4 presents a flow chart illustrating a method for generating an updated schedule in accordance with an embodiment.

FIG. 5A illustrates an exemplary schedule created by a user in accordance with an embodiment.

FIG. 5B illustrates an exemplary schedule that has been automatically updated in accordance with an embodiment.

FIG. 5C illustrates an exemplary schedule that includes an optimal route for a user in accordance with an embodiment.

FIG. 51) illustrates an exemplary schedule that includes an optimal route that has been automatically updated in accordance with an embodiment.

FIG. 6 illustrates a user interface that presents a recommended scheduled activity to a user in accordance with an embodiment.

FIG. 7 presents a flow chart illustrating a method for providing a recommended schedule modification to a user in accordance with an embodiment.

FIG. 8 illustrates an exemplary apparatus that facilitates automatically updating a user's schedule in accordance with an embodiment.

FIG. 9 illustrates an exemplary computer system that facilitates automatically updating a user's schedule in accordance with an embodiment.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

### Overview

Embodiments of the present invention solve the problem of providing an automatic calendar-managing system, which can automatically optimize a user's calendar in response to detecting a schedule-modifying event. The system can analyze data from several sensor streams related to a user or organization, and can use information from these sensor streams to update a calendar model for the user or the organization. This calendar model includes a set of activities (e.g., multiple inter-related activities) that form a schedule for the user or organization.

For example, as a user progresses through his day, the system can automatically optimize the user's schedule to accommodate any new tasks that need to be performed, or to accommodate any last-minute changes to the user's schedule. If the system determines that the user needs to perform a task that is not currently in his calendar, or if the user creates or updates a calendar entry in a way that creates a sub-optimal schedule, the system can automatically update one or more of the user's calendar entries to create an optimized schedule.

In some embodiments, the system can use the information related to the user to determine which activity the user may be performing, and/or to recommend changes to the user's schedule. For example, the system can use this user information to determine whether the user is performing a scheduled activity from his calendar, to determine whether the user is available to complete an action item from his calendar or task queue, or to determine whether the user may not be able to complete a scheduled activity on his calendar.

The system can also use information related to the user or to other users (e.g., other participants of a scheduled activities) to coordinate activities between the user and the other users. For example, the system can perform complex activity planning or enterprise task scheduling within an organization to account for various personal or business goals (e.g., a project deadline). Organizations oftentimes perform similar activities from project to project, and may perform some of these activities in a similar sequence. The system can use historical activity information from past projects to determine a sequence in which a project's activities need to occur. The system can keep track of a plurality of tasks and/or scheduled activities from the organization (e.g., related to the project), and can dynamically reschedule tasks or activities to preserve an activity order or to mitigate any scheduling conflicts.

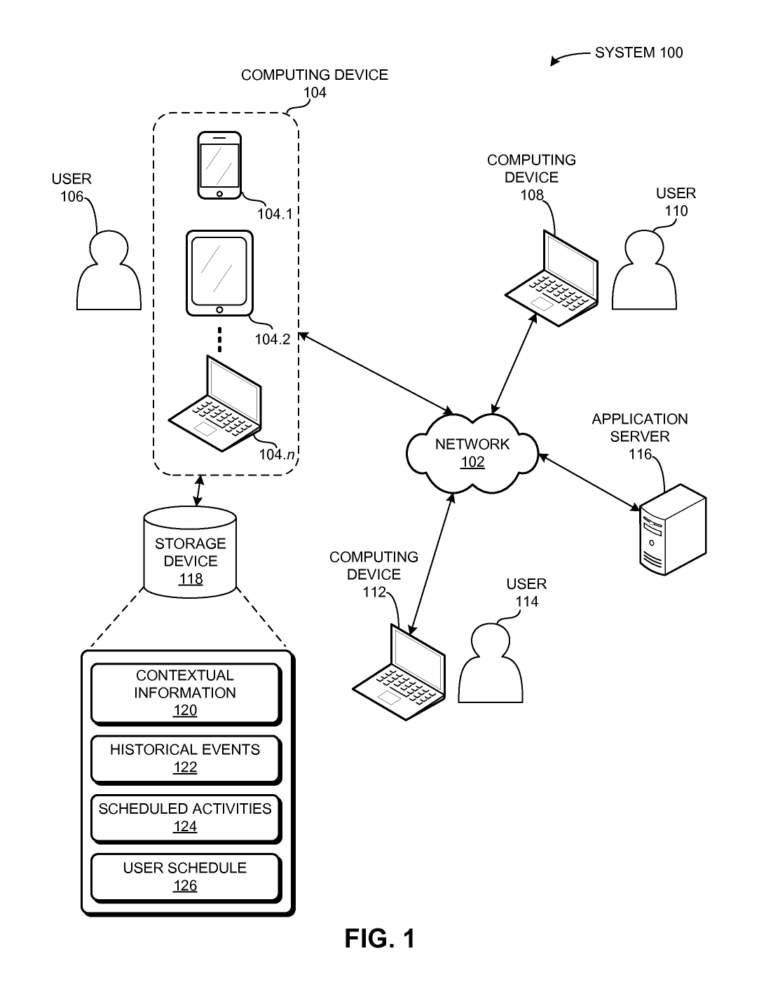

FIG. 1 illustrates an exemplary computer system 100 that facilitates automatically updating an activity schedule for a user in accordance with an embodiment. Computer system 100 can include a computer network 102, which can include any wired or wireless network that interfaces various computing devices to each other, such as a computer network implemented via one or more technologies (e.g., Bluetooth, Wi-Fi, cellular, Ethernet, fiber-optic, etc.). Computer system 100 can also include a computing device 104 coupled to network 102 and associated with a user 106, such as an portable computing device that user 106 can travel with, use to communicate with others, perform tasks, and manage a personal or shared calendar. For example, computing device 104 can include a smartphone 104.1, a tablet computer 104.2, or any other personal computing device 104.n such as a laptop computer, a desktop computer, etc.

As user 106 performs activities throughout the day (e.g., travels to certain locations, meets with others, accesses certain electronic documents, updates a personal or shared calendar, etc.), computing device 104 can gather contextual information for user 106 that facilitate determining activities being perforated by user 106, and determining whether a calendar associated with user 106 needs to be updated and/or optimized.

In some embodiments, computing device 104 and/or an application server 116 can dynamically update the activities and schedules for user 106 in real-time as user 106 progresses through his day. Computing device 104 can also present user 106 with any changes to his schedule, as well as any information related to his activities and/or schedule (e.g., travel information, information related to other activity participants, relevant documents, a list of items to bring to the activity, relevant coupons or advertisements, etc.).

During operation, computing device 104 can analyze the gathered information related to user 106 to determine an activity being performed by user 106, and to determine whether the activity affects a schedule associated with user 106 (e.g., whether the activity is a schedule-modifying event). Also, computing device 104 can periodically send the gathered information to application server 116, and application server 116 (e.g., a corporate server, or a server that provides a calendar-managing service) can analyze the gathered information to determine whether the activity being performed by user 106 affects a schedule associated with user 106 or some other entity. For example, user 106 may oftentimes work on projects with users 110 and 114, such that they may be participants of a common set of scheduled activities. Application server 116 may maintain calendar information for these scheduled activities in a shared calendar, or in separate calendars for each of these users.

If user 106 is running late to a meeting, computing device 104 can update the calendar activity by postponing the activity to a later date, and can send the modified activity to application server 116 (alternatively, application server 116 can modify the calendar activity after detecting that user 106 is running late based on his contextual information). If application server 116 determines that the modified activity causes a scheduling conflict with other calendar activities associated with user 106, 110, and/or 114 (e.g., detects overlapping activities, or determines that the modified activity is scheduled at a date later than other follow-up meetings), application server 116 can automatically reschedule the necessary activities to correct or mitigate the scheduling conflicts.

In some embodiments, computing device 104 can include or be coupled to a storage device 118, which can store contextual information 120 for user 106 and/or historical events 122 in which user 106 has been involved. Computing device 104 can determine contextual information 120 either periodically (e.g., to record a behavior trace for user 106), or when user 106 performs a certain action (e.g., when user 106 interacts with device 104, or device 104 moves from one cellular or wireless network to another). Storage device 118 can also store profile information for user 106, such as to include entity associations that indicate contact information to a plurality of entities, and can indicate how user 106 is associated with each of these entities (e.g., relationship type, shared group associations, etc.). The system can obtain or detect these entity associations based on the user's contact list or address book, an online social network, and/or previous communications between the user and these entities.

In some embodiments, computing device 104 can periodically monitor one or more local sensors to collect contextual information 120 related to user 106, such as a location and/or a motion trajectory for user 106. Examples of contextual information include, but are not limited to: GPS coordinates, location details for calendar entries, travel data, social network location updates, etc. Computing device 104 can also monitor signals from other devices (e.g., Bluetooth, and/or RFID signals) to collect contextual information about the surroundings to user 106, such as other entities that user 106 is interacting with. For example, computing device 104 can identify other nearby individuals (e.g., via a Bluetooth signal from a person's smartphone) or devices (e.g., via an RFID or Bluetooth signal emitted by the user's car). The contextual information can indicate the name of the entity being monitored, a timestamp or time range, and/or a location.

In some embodiments, computing device 104 can monitor electronic activities associated with user 106 to collect contextual information that indicates other remote entities that user 106 is interacting with, such as by detecting online communication activities with a remote entity (e.g., via an online chat client, a teleconference session, a videoconference session, a voice message or conversation, online social network activity, an Email, or a simple messaging service (SMS) message), a network connection with a remote entity (e.g., a virtual private network (VPN) connection to the user's employer), etc. Computing device 104 can also collect contextual information from electronic media that user 106 interacts with, such as documents, multimedia content, applications, websites, etc. The contextual information can indicate the name of the electronic media, timestamp or time range from which the contextual information was obtained, and/or access information for the electronic media (e.g., a storage location, a website address, a software application used to access the content, etc.).

In some embodiments, storage device 118 can also store scheduled activities 124 for user 106, and a user schedule 126 (e.g., a calendar) for user 106. A scheduled activity can include a location, a set of participants, a time range, and activity-related information. The activity-related information, for example, can include location-related information, transportation information, a coupon or advertisement, a list of items that user 106 needs to bring to the scheduled activity, an electronic document related to the scheduled activity, information about other participants of the scheduled activity, and/or itinerary-related information for the scheduled activity.

### Automatic Calendar-Managing System

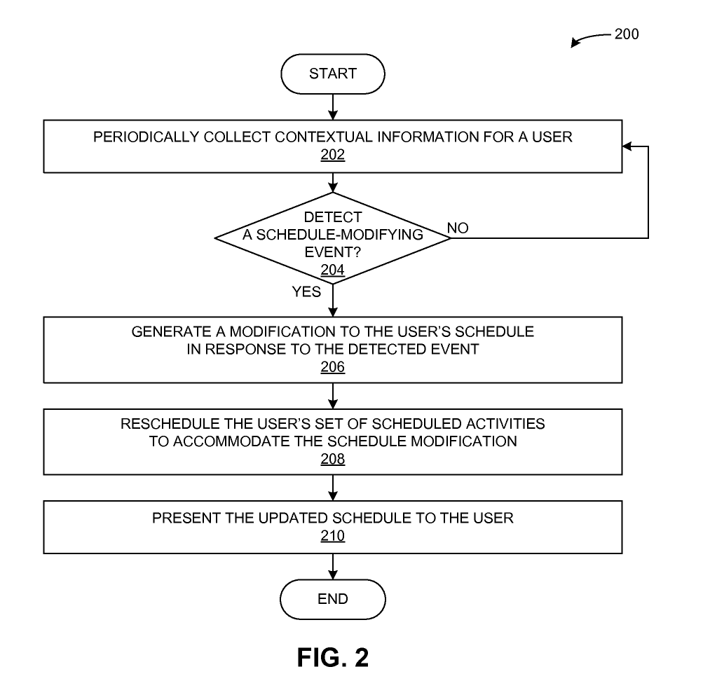

FIG. 2 presents a flow chart illustrating a method 200 for rescheduling a user's activities in accordance with an embodiment. During operation, the system can periodically collect contextual information related to a user (operation 202), such as any information that can be used to derive a current behavior or activity being performed by the user. This contextual information can include user contexts, such as current calendar items, a current time, a user location, other entities within a threshold proximity to the user, a weather conditions, web content, etc. The contextual information can also include activity contexts, such as an activity location, an activity start time and/or end time, participants of an activity, etc. Further, the contextual information can also include historical contexts, such as past user activities, past calendar items, location traces, etc.

The system can analyze this contextual information to determine whether the user is performing an activity which affects a schedule associated with the user. The system can identify activities that the user is engaged in, and/or activities that the user is not currently engaged in. The system can also identify activities or tasks that the user has performed, or may not have performed, within a determinable time period (e.g., performed the activity within the current day, week, month, etc.).

The system then determines whether it detects a schedule-modifying event from the contextual information and from the derived activities that the user may or may not be engaged in. The schedule-modifying event indicates an activity or event that affects a schedule associated with the user. For example, if the user is scheduled to call an insurance agent, the user may need to call the agent before 5 PM (before the insurance agent leaves work). If the system determines that it is 4:30 PM and that the user has not called the insurance agent, the system can remind the user that he still needs to call the insurance agent. As another example, if the user is scheduled to perform an outdoor activity, the schedule-modifying event may include a change in weather that can require the activity to be moved to an indoor location, or to be postponed to a later date as determined by a weather forecast.

If a schedule-modifying event has occurred, the system generates a modification to the user's schedule in response to the detected event (operation 206). The schedule modification may include a reminder for the user, such as a reminder to a task that the user needs to complete before a given deadline, or a reminder for a scheduled activity whose deadline has arrived or has passed. The system then automatically reschedules the user's set of scheduled activities to accommodate the schedule modification (operation 208), and presents the updated schedule to the user (operation 210).

The schedule modification, for example, can include a modification to other scheduled activities to optimize the user's overall schedule based on a predetermined scoring metric. In some embodiments, the system generates various alternative schedules, and computes a score for each alternative schedule by processing each alternative schedule using a utility function that implements the scoring metric. The scoring metric can score a schedule based on how well the schedule follows the activities' priority levels or importance scores, activity deadlines, or schedule dependencies. The scoring metric can also score a schedule based on how well it minimizes a time duration between or during scheduled activities, a travel time or distance travelled between scheduled activities, a cost for rescheduling the activities, or a cost for missing a deadline.

TABLE 1
event_queue = push(pre-defined_activities);
new_event = pop(event_queue);

| 1. | IF | new_event == NULL |
|---|---|---|
| | | new_event = pop(event_queue); |
| | | GOTO Step 1; |
| | ELSE | |
| | | GOTO Step 2; |
| 2. | IF | new_event is an activity change from A to A′: |
| | | Update contextual information for A′ to match A′; |
| | | Update pro-active reminder, other relevant information, |

and/or relevant people to the user and other activity
participants

CALL optimization routine, substituting A with A′ in

activity set;

| | | |
|---|---|---|
| 3. | IF | new_event is a new activity A″: |
| | | Derive missing contextual information related to A″; |
| | | Derive pro-active reminder, other relevant information, |

and/or relevant people to the user and other activity
participants

Derive any latent activity set AL
IF AL == empty THEN

CALL optimization routine, adding A″ to activity set;

ELSE

event_queue = Push(event_queue, AL);

GOTO Step 1;

Table 1 presents exemplary pseudocode for dynamically rescheduling the user's activities in accordance with an embodiment. During operation, when the system or the user creates a new activity, the system can insert this new activity into a queue (or any other data structure). The system processes the activities in the queue to determine the best way to incorporate the activity into the user's schedule. If the new activity is a modified version of a scheduled activity (step 2), the system can update the new activity to include any missing information that exists in the scheduled activity and/or to proactively modify the new activity based on the user's contextual information. The system then replaces the existing scheduled activity with the new activity, and optimizes the user's overall schedule to accommodate the new activity.

If the activity from the queue is a new activity (step 3), the system can derive any missing information related to the activity (e.g., from the user's current and/or historical activities). The derived information can include any missing contextual information (e.g., location, weather forecast, traffic conditions, etc.), a pro-active reminder (start time and end time), other participants to the activity, any relevant information (e.g., documents or any other physical or electronic items that the user needs to bring to the activity). The system can also derive any other activities that need to be added to the queue (e.g., activities that follow the new scheduled activity), and optimizes the user's overall schedule to accommodate the new activity as well as any derived activities.

In some embodiments, the system can derive other participants that may need to be involved in an activity (e.g., colleagues or experts to consult in a meeting) using information from an online social network related to the user. The system can reach out to the user's friends and/or colleagues that have shown a clear interest in the activity or meeting, for example, by matching a name or description of the activity to interest lists for each of the friends or colleagues. The user's friends or colleagues can generate this interest lists themselves, or the system can generate an interest list for each friend or colleague based on messages exchanged with these friends or colleagues (e.g., mails, online chat conversations, etc.), or based on information they have shared via the online social network.

TABLE 2

| | Schedule-Modifying | |
|---|---|---|
| No. | Event | Schedule Modification |
| 1a | User is not busy | Create an activity to complete a pending |
| | | task. |
| 1b | | Reschedule an existing activity to an |
| | | earlier date. |
| 2 | User and participant(s) | Modify the existing activity to relocate the |
| | of an existing activity | activity to an earlier date, and to |
| | are available and in | recommend a meeting location. |
| | close proximity to | |
| | each other. | |
| 3a | User has missed a | Reschedule the missed activity to a |
| | scheduled activity. | later date. |
| 3b | | Cancel the missed activity. |
| 4a | A participant has not | Reschedule the activity to a later date |
| | accepted a scheduled | |
| | activity or has missed | |
| | the activity. | |
| 4b | | Modify the activity to remove the |
| | | participant. |

Table 2 presents a list of exemplary schedule-modifying events and their corresponding schedule modifications in accordance with an embodiment. If the system determines that the user is not busy, the system can create an activity to complete a pending task (modification 1a), or to reschedule an existing activity to an earlier date (modification 1b). If the system determines that the user and participant(s) of an existing activity are available and in close proximity to each other, the system can modify the existing activity to reschedule the activity to an earlier date and to recommend a meeting location (modification 2).

If the system determines that the user has missed an activity, the system can reschedule the missed activity to a later date (modification 3a), or can cancel the missed activity (modification 3b). If a participant has not accepted a scheduled activity or has missed the activity, the system can reschedule the activity to a later date (modification 4a), or can modify the activity to remove the participant (modification 4b).

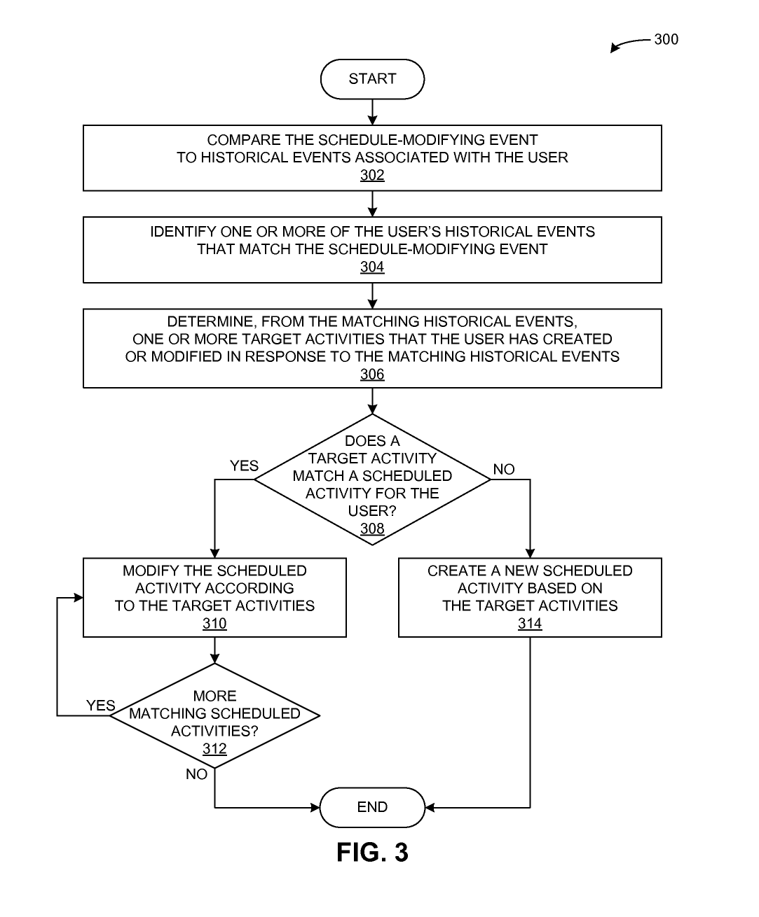

FIG. 3 presents a flow chart illustrating a method 300 for generating a recommended modification to the user's schedule in accordance with an embodiment. During operation, the system compares the schedule-modifying event to historical events associated with the user (operation 302), and identifies one or more of the user's historical events that match the schedule-modifying event (operation 304). These historical events can include contextual, behavior, or activity information that was collected or detected about the user prior or during the time the user modified his schedule in the past. The historical events can also include historical activities that have been entered into the user's schedule in the past.

The system then determines, from the matching historical events, one or more target activities that the user has created or modified in response to the matching historical events (operation 306). The target activities can include scheduled activities that the system has recommended to the user in the past (in response to the schedule-modifying event), and which the user has accepted into his personal calendar. Other target activities can include previous modifications to a scheduled activity that have been entered in response to the schedule-modifying event (e.g., automatic modifications by the system, or manual modifications by the user).

For example, the system can analyze the target activities to determine a common element (e.g., a location, one or more participants, a temporal value, and/or any activity-related information) that exists in at least a threshold number or percentage of target activities. In some embodiments, the temporal value can be an absolute value, such as a time of day, day of the week, day of the month, and/or day of the year that the user typically performs a certain activity. The temporal value can also be an absolute value, such as a time duration between the historical events and their corresponding target activities (e.g., a number of hours or days after a historical event at which the user schedules or performs an activity in response to the event). In some embodiments, the temporal value can be derived from both a relative value and an absolute value. For example, the system may determine to schedule an activity two weeks after the schedule-modifying event (a relative temporal value), on a Monday at 3:00 PM (an absolute temporal value).

If at least one common element is found, the system can use these common elements to create or modify a scheduled event for the user. For example, the system can determine whether a target activity matches one or more of the user's scheduled activities (operation 308). If so, the system can modify an existing activity according to the target activities (operation 310). The system can also modify multiple activities in the user's calendar as necessary by determining whether more scheduled activities in the user's calendar match the target activity (operation 312). If so, the system can return to operation 310 to modify another matching scheduled activity.

However, if the system determines during operation 308 that the target activity does not match a scheduled activity from the user, the system can create a new scheduled activity based on the common elements of the target activities (operation 314). The system can also derive other elements for the new scheduled activity from other historical activities that the user or the system has scheduled for the user (e.g., other historical activities related to the new activity, which may not have been scheduled in response to the schedule-modifying event).

In some embodiments, the target activity can include an activity that is periodically repeated by the user, and that is not in the user's set of scheduled activities. For example, the target activity can include the user getting a haircut, or taking his car to an auto shop for an oil change. If the system determines that the user has not yet scheduled (e.g., as determined by the user's calendar entries) or performed (e.g., as determined by the user's GPS or activity trace) the periodic activity, the system can create and schedule the activity for the user.

In some embodiments, the target activity can include an activity that is historically correlated to an activity in the user's set of scheduled activities (e.g., the user may perform the target activity during the same day or near the time/day that the user also performs one or more of the user's scheduled activities). The system can detect the correlation, for example, by computing a correlation coefficient using the user's historical activities, and determining that the correlation coefficient is greater than a predetermined threshold. For example, the system may determine that the user oftentimes schedules his haircut and oil-change activities in the same day, in any order. If the user has already created a scheduled activity for taking his car to get an oil change, the system can allocate a time block from his schedule for also getting a haircut (if the user has not gone to get a haircut recently).

The target activity can also include an activity that the user performs after one or more activities in the user's set of scheduled activities (e.g., the user performs the target activity sometime after, or in response to, performing an activity that is similar to one of the user's scheduled activities). For example, the system can determine that the user oftentimes (e.g., by computing a correlation coefficient) schedules an engineering or design group meeting the day after meeting with a client. Thus, if the system detects that the user has scheduled a meeting with a client, or detects that the user is meeting with the client (e.g., as a sudden, unscheduled event), the system can respond by creating a scheduled event for meeting with his team. This scheduled event can be derived from the detected target activities, for example, by including an activity name, date, and/or location that is derived from the previous target activities, and by including the participants from the target activities.

The system may use the target activities and the other historical activities to determine the types of information that the user may need to prepare for the activity. For example, the system may determine a description for the types of document that the user may need, such as “marketing material,” “financial spreadsheet,” etc. The system can include these general descriptions within the scheduled activity to remind him of the additional material that he'll need to bring with him to the scheduled activity. As another example, if these historical events include electronic documents as an attachment, the system may analyze these documents to determine a file type for an electronic document and/or to derive a file path for obtaining documents for the new activity. For example, if the new scheduled activity is for a group meeting regarding a project “Alpha,” the system may search for the relevant documents that include “Alpha” in the name and/or path, as well as the desired file type extensions. If the system finds electronic documents that are relevant to the new activity, the system can attach these documents to the new scheduled activity to allow the user to access the information at his convenience.

Once the system has generated or modified a scheduled activity, the system can proceed to optimize a plurality of scheduled activities for the user. It may be necessary for the system to optimize the user's overall schedule because the new or modified scheduled activity may introduce a scheduling conflict with other existing activities (e.g., due to overlapping schedules, or when several associated activities are scheduled out-of-sequence).

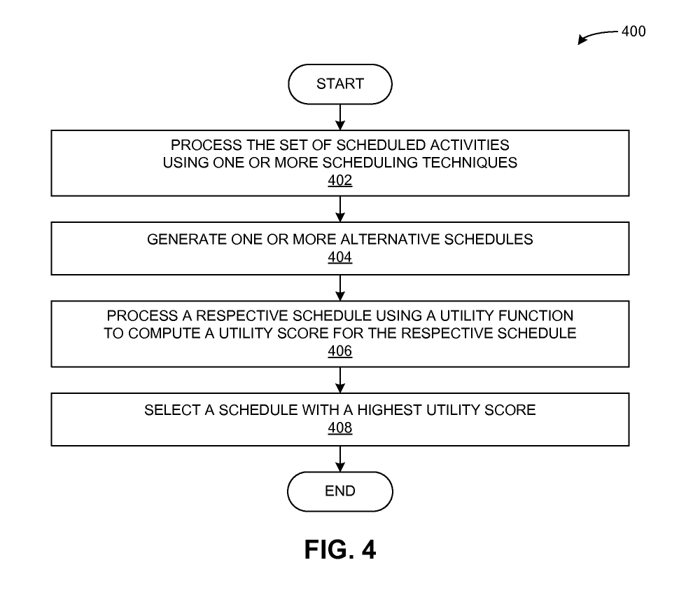

FIG. 4 presents a flow chart illustrating a method 400 for generating an updated schedule in accordance with an embodiment. During operation, the system processes a set of scheduled activities using one or more scheduling techniques (operation 402), and generates one or more alternative schedules (operation 404). For example, the system can generate an initial schedule by assigning activities to their corresponding time intervals, allowing for overlaps in their time intervals. These time overlaps result in scheduling conflicts, which require the system to select a schedule that resolves these conflict while minimizing the consequences to the user. The system can then generate every possible permutation that resolves these conflicts (e.g., resolving a scheduling conflict by selecting one of the overlapping schedules for each permutation). In some embodiments, the system generates a subset of the permutations by using a set of predetermined activity-selecting algorithms (e.g., selecting the activity that has a shortest duration, a highest cost, a highest importance, a lowest scheduling flexibility, and/or an oldest entry date). For example, if the user's goal is to meet activity time constraints (e.g. the user's most important goal is to arrive to all meetings on time), then the system can generate one or more alternative schedules using deadline-based scheduling techniques.

In some embodiments, the activities (e.g., scheduled activities, or unscheduled tasks or to-do items) within the calendar is represented as a tuple:

A=<activity_name,start_time,end_>.

The start and end times are tentative. They may be specified explicitly by the user (e.g., fora meeting/appointment), or they may be unknown (e.g., for unscheduled task items). During operations 402-404, the system can schedule the entire set of activity tuples using a strategy defined based on the user's context. The resulting schedule includes finalized start time and end time for each task and activity.

The system then generates a utility score for each of the generated schedules by using a utility function to process each of these schedules (operation 406), and selects a schedule with a highest utility score (operation 408). The utility function can include a function that takes as input a sequence of scheduled activities, and computes a utility score for the schedule. The utility function can compute the score based on how well the schedule abides by the activities' priority levels or importance scores, activity deadlines, or schedule dependencies. The utility function can also compute the score based on how well the schedule minimizes a time interval between scheduled activities, minimizes a travel time duration or a distance travelled between scheduled activities, minimizes a cost for rescheduling the activities, or minimizes a cost for missing a deadline.

In some embodiments, the utility function captures the user's contextual goals based on contextual factors such as total time spent on the scheduled tasks, time gap between activities, distance travelled, cost, and activity priority or importance score. For example, a utility function based on the total distance the user traverses to perform the set of scheduled activities A, may be:

Util(A)=Σ_{i=1, . . . ,n}Dist(Aᵢ,Aᵢ₊₁)

When the system generates a modification to the user's schedule (e.g., during operation 206), the system can present a user interface (UI) to communicate the modification to the user. The user can interact with the UI to indicate whether the user accepts the proposed modification. Further, the system can optimize the user's schedule through incremental steps. For example, when the user makes a change to or deviates from a schedule, the system can automatically optimize only the other scheduled activities that depend on the activity that changed in the user's schedule.

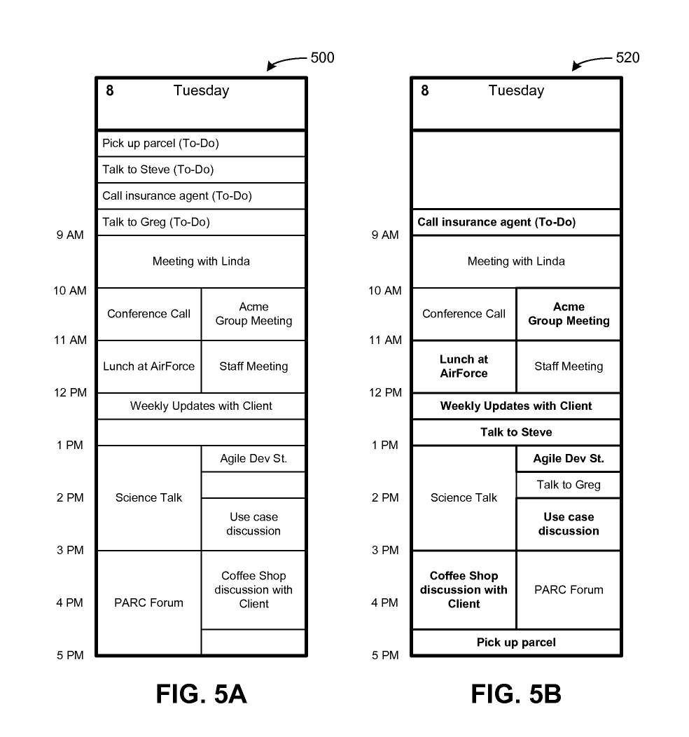

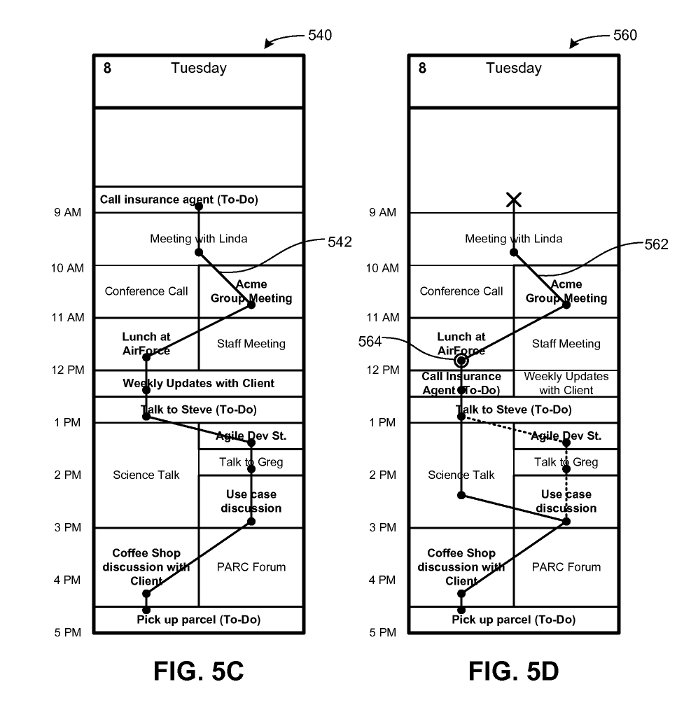

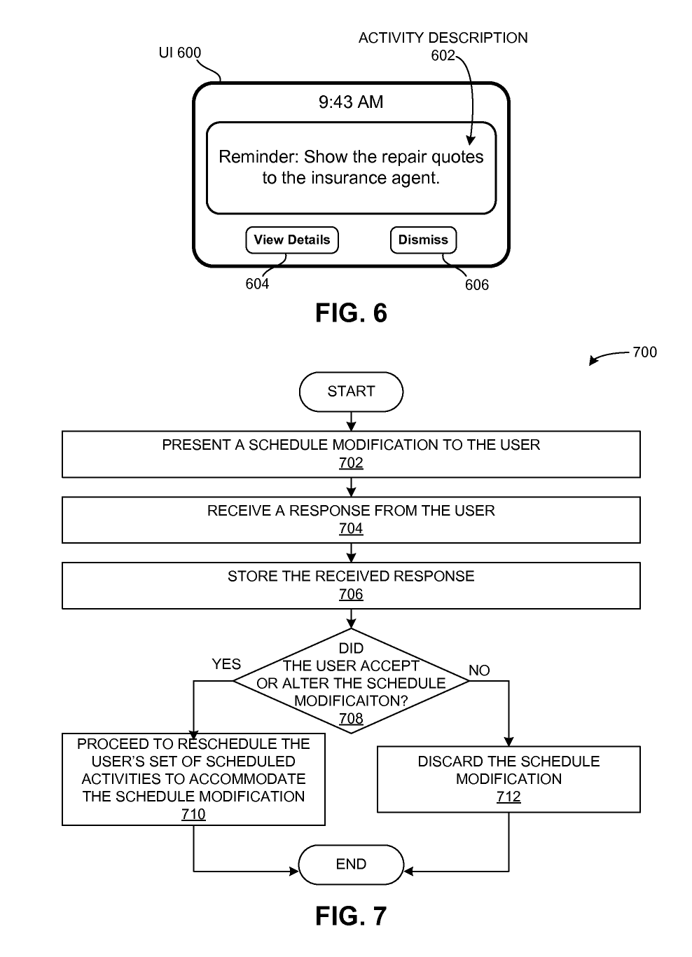

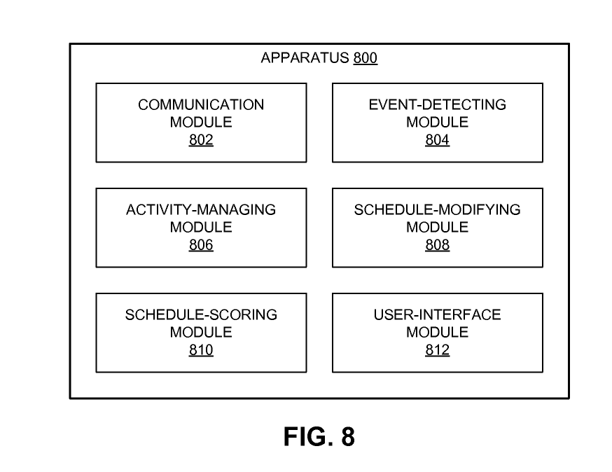

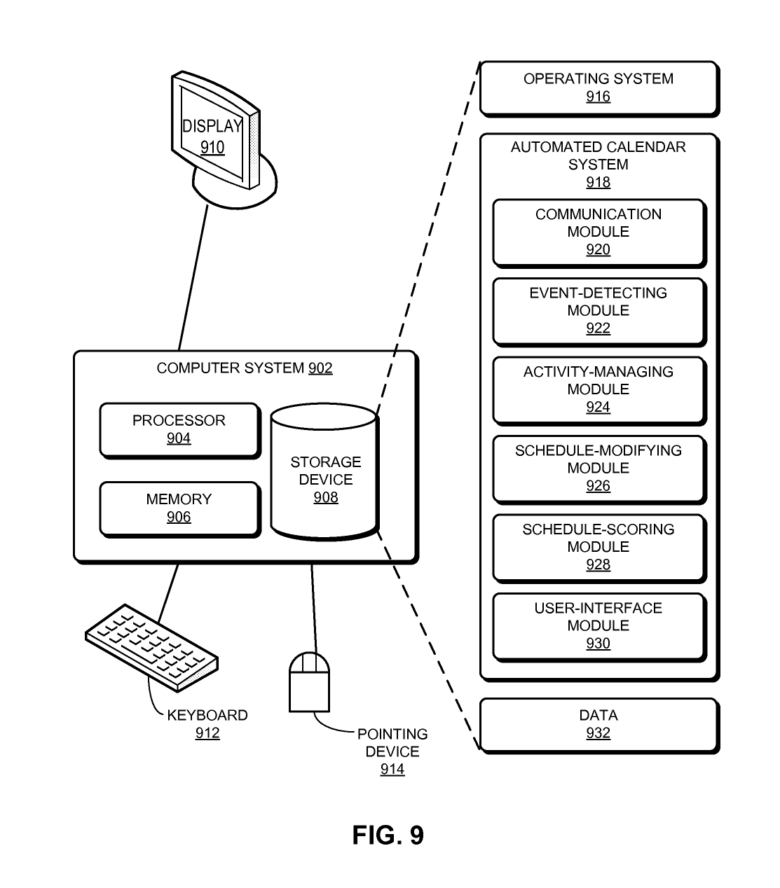

FIG. 5A illustrates an exemplary schedule 500 created by a user in accordance with an embodiment. Schedule 500 includes a plurality of task items (e.g., unscheduled to-do items) and planned appointments (e.g., scheduled activities) that the user has entered into schedule 500 and/or that the system has derived for the user. In schedule 500, there may be some scheduled activities that have conflicting time slots (e.g., alternative activities for the user). To present the alternative activities to the user, the system can display the conflicting activities side-by-side. For example, in some embodiments, the entry items on the left half of schedule 500 indicate activities that the user has explicitly entered into his schedule, and the entry items on the right indicate alternative activities that have been entered by the user or by others (e.g., activities created by other participants, and/or activities that the system has automatically derived for the user).

For example, the system may have derived the “ACME group meeting” at 10 AM, the “Staff Meeting” at 11 AM, the “Agile Development Strategy” meeting at 1 PM, the “Use-case discussion” meeting at 1:30 PM, and the “Coffee Shop discussion with Client” at 3 PM. The system can also intelligently derive additional task items that the user may be interested in performing (e.g., as determined from a latest sequence of items on the calendar and the user's previous event and activity information), but that the user has not entered into his calendar schedule. For example, the system may determine that the user needs to “pick up parcel,” and “call insurance agent,” “talk to Steve,” and “talk to Greg” based on email, SMS, and/or voicemail messages that the user has received (and/or any other contextual information related to the user).

Further, the system can automatically derive location, participant, and priority or importance information for each individual activity and task item (which have been entered by the user and/or the system) based on the user's historical information (e.g., the user's previous behavior patterns as determined from location traces, email/txt communications, person proximity etc.). Thus, in schedule 500, the user and/or the system has created or augmented a list of appointments and four task items that are either linked to locations (insurance agent, pick up parcel) or to people (talk to Steve, talk to Greg).

The system can dynamically schedule and/or re-schedule task items into the user's schedule by maintaining a global model of the user's task items and goals that spread over an extended time interval (e.g., several days, weeks and months, etc.) For example, the system can dynamically schedule and/or re-schedule the user's task items and appointments to other days or weeks according to the user's preferences priorities.

As mentioned earlier, the system periodically optimizes the user's activity schedules based on the user's goals, priorities, contexts, and preferences (e.g., as derived from the user's historical information). The system optimizes the activity scheduling against a utility function, which generates a utility score for a schedule based on one or more contextual metrics that are important to the user.

FIG. 5B illustrates an exemplary schedule 520 that has been automatically optimized in accordance with an embodiment. In schedule 520, the entry items in bold indicate activities that the system has automatically derived or modified for the user.

After the user has created a schedule for the day and the system has derived tasks and activities for the user, the system computes a priority for the individual task and activity items and integrates these task items into the user's schedule for the day. For example, the system can schedule the task “talk to Steve” during the user's free time between 12:30 PM and 1 PM, and schedules the task “talk to Greg” during a possible free time block for the user between 1:30 PM and 2 PM. The system may also schedule the task “pick up parcel” at the end of the user's workday, but before the parcel service closes for the day.

Also, based on the determined priorities, the system can recommend which activities the user should select. For example, between 10 AM and 11 AM, the system can recommend that the user be on time to the “ACME group meeting,” even though the user had previously scheduled a conference call during this time block (e.g., the user had forgotten about the weekly group meeting). Also, even though the system generated a scheduled activity for a “staff meeting” that occurs bi-weekly, the system may recommend that the user keep his previously-scheduled activity “Lunch at Air Force,” given that the Air Force is an important contact to the user.

As a further example, the weekly activities “Science Talk” and “PARC Forum” don't have a mandatory attendance (which the system has determined based on the local user's and/or other participants' sparse attendance to these events). Hence, the system assigns a low priority or importance score to these two scheduled activities, which results in the system recommending that the user attend the other alternative scheduled events (e.g., the “Agile Development Strategy,” “Use-case discussion,” and “Coffee Shop Discussion with Client” activities).

FIG. 5C illustrates an exemplary schedule 540 that includes an optimal route 542 for a user in accordance with an embodiment. Optimal route 542 includes a line, which indicates a sequence of scheduled activities that the user should follow. Further, optimal route 542 can include bullet points that indicate which activities belong to the sequence of scheduled activities.

The system can add task items and activities to the sequence according to the user's ability to navigate from one scheduled activity to a subsequent activity in the sequence (e.g., based on an activity's location and its reachability from a previous activity's location). The system can present reminders to the user to leave on time and/or to prepare for a task or a scheduled activity. For example, if a task or activity takes place at an offsite location, the system can remind the user of which materials he needs to take with him, and can present a reminder early enough to allow the user to collect the necessary materials and to arrive at the offsite location on time (e.g., to print or obtain repair quotes for an insurance agent before leaving the office after work).

FIG. 5D illustrates an exemplary schedule 560 that includes an optimal route 562 that has been automatically updated in accordance with an embodiment. In some embodiments, the system routinely adjusts the optimal route (e.g., periodically, or in response to detecting an activity-modifying event) as the user navigates through the day. The system can insert, modify, or remove tasks or activities to/from optimal route 562 to account for any changes to the user's behavior and/or the user's environment (e.g., changes in the user's location, the weather, traffic conditions, etc.).

Further, schedule 560 can also include a marker 564 which indicates where the user is within optimal route 562. For example, marker 564 can indicate that the user is currently eating “Lunch at Air Force.” Further, if while the user is having lunch at the Air Force base or talking to Steve at Steve's office the system detects that the current traffic conditions may cause the user to arrive late or even miss the “Agile Development Strategy” meeting, the system can present an alternative schedule for the user. The “Science Talk” may be at a venue close to Steve's office, and along the way to the venue for the “Use Case Discussion,” In this case, the system can recommend the user to listen to a portion of the “Science Talk” while the traffic clears up, and can even remind the user when it's time for the user to leave the Science Talk to attend the “Use Case Discussion” meeting (while accounting for real-time updates to the traffic conditions).

FIG. 6 illustrates a user interface 600 that presents a proposed scheduled activity to a user in accordance with an embodiment. UI 600 can include an activity description 602, a view-details button 604, and a dismiss button 606.

In some embodiments, activity description 602 can include a brief description of a scheduled activity in the user's calendar. If the user clicks on dismiss button 606, the system can discard UI 600, and can remove the activity from the user's schedule. The system can also proceed to optimize the user's overall schedule (which can include a plurality of scheduled activities) in response to the user ignoring the scheduled activity. If the user clicks on view-details button 604, the system can present a different UI (or expand UI 600) to include detailed activity information for the scheduled activity. The user can interact with this UI (not shown) to modify or hide the scheduled event. The system can also proceed to modify the user's overall schedule if the user modifies the scheduled activity.

In some embodiments, activity description 602 can include a brief description of the activity being added or modified for the user. If the user clicks on dismiss button 606, the system can discard UI 600 without entering the proposed activity into the user's schedule. If the user clicks on view-details button 604, the system can present a different UI (or expand UI 600) to include detailed activity information for the new or modified scheduled activity. The user can interact with this UI to accept or dismiss the proposed schedule modification. If the user accepts the proposed scheduled activity, the system can proceed to modify the user's overall schedule to accommodate the proposed scheduled activity.

FIG. 7 presents a flow chart illustrating a method 700 for providing a recommended schedule modification to a user in accordance with an embodiment. During operation, the system can present a schedule modification to the user (operation 702). For example, the system can present a UI that reminds the user of a task or displays a change to a scheduled activity. The user can accept or modify the activity after viewing the details, or the user can dismiss the UI to ignore the proposed activity. The system receives the response from the user when the user interacts with the UI (operation 704), and stores the received response in a repository that includes historical events and user responses (operation 706).

The system then determines if the user accepted or modified the schedule modification (operation 708). If the user accepted or modified the schedule modification, the system proceeds to reschedule the user's set of scheduled activities to accommodate the schedule modification (operation 710). However, if the user dismissed the UI, the system can discard the schedule modification without rescheduling the user's scheduled activities (operation 712).

FIG. 8 illustrates an exemplary apparatus 800 that facilitates automatically updating a user's schedule in accordance with an embodiment. Apparatus 800 can comprise a plurality of modules which may communicate with one another via a wired or wireless communication channel. Apparatus 800 may be realized using one or more integrated circuits, and may include fewer or more modules than those shown in FIG. 8. Further, apparatus 800 may be integrated in a computer system, or realized as a separate device which is capable of communicating with other computer systems and/or devices. Specifically, apparatus 800 can comprise a communication module 802, an event-detecting module 804, an activity-managing module 806, a schedule-modifying module 808, a schedule-scoring module 810, and a user-interce module 812.

In some embodiments, communication module 802 can communicate with a remote data repository to send and/or receive contextual information, activity information, tasks, scheduled activities, user preferences, and/or user-profile information related to a user. Event-detecting module 804 can detect a schedule-modifying event, which is likely to require the user to modify a set of scheduled activities. Activity-managing module 806 can generate a schedule modification to the user's schedule to account for the detected event. Schedule-modifying module 808 can reschedule the user's set of scheduled activities to accommodate the schedule modification. Schedule-scoring module 810 can process one or more generated schedules using a utility function to compute a utility score for the respective schedules. User-interce module 812 can present the schedule modification to the user and receive a response to the schedule modification from the user.

FIG. 9 illustrates an exemplary computer system 902 that facilitates automatically updating a user's schedule in accordance with an embodiment. Computer system 902 includes a processor 904, a memory 906, and a storage device 908. Memory 906 can include a volatile memory (e.g., RAM) that serves as a managed memory, and can be used to store one or more memory pools. Furthermore, computer system 902 can be coupled to a display device 910, a keyboard 912, and a pointing device 914. Storage device 908 can store operating system 916, automatic calendar system 918, and data 932.

Automatic calendar system 918 can include instructions, which when executed by computer system 902, can cause computer system 902 to perform methods and/or processes described in this disclosure. Specifically, automatic calendar system 918 may include instructions for communicating with a remote data repository to send and/or receive information related to a user's profile, contextual information, schedule, and/or activities (communication module 920). Further, automatic calendar system 918 can include instructions for detecting a schedule-modifying event, which is likely to require the user to modify a set of scheduled activities (event-detecting module 922). Automatic calendar system 918 can include instructions for generating a schedule modification to the user's schedule to account for the detected event (activity-managing module 924).

Automatic calendar system 918 can also include instructions for rescheduling the user's set of scheduled activities to accommodate the schedule modification (schedule-modifying module 926). Automatic calendar system 918 can include instructions for processing one or more generated schedules using a utility function to compute a utility score for the respective schedules (schedule-scoring module 928). Automatic calendar system 918 can also include instructions for presenting the schedule modification to the user and receive a response to the schedule modification from the user (user-interface module 930).

Data 932 can include any data that is required as input or that is generated as output by the methods and/or processes described in this disclosure. Specifically, data 932 can store at least contextual information, activity information, tasks, scheduled activities, user preferences, and/or user-profile information related to the user.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing computer-readable media now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, the methods and processes described above can be included in hardware modules. For example, the hardware modules can include, but are not limited to, application-specific integrated circuit (ASIC) chips, field-programmable gate arrays (FPGAs), and other programmable-logic devices now known or later developed. When the hardware modules are activated, the hardware modules perform the methods and processes included within the hardware modules.

The foregoing descriptions of embodiments of the present invention have been presented for purposes of illustration and description only. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A computer-implemented method, comprising:
detecting a schedule-modifying event for a user, wherein the schedule-modifying event includes an event which is likely to require the user to modify a set of scheduled activities;
generating a schedule modification, which includes at least one change the user's set of scheduled activities, to account for the schedule-modifying event; and
rescheduling the user's set of scheduled activities to accommodate the schedule modification.

2. The method of claim 1, wherein a scheduled activity includes at least one of:
a location;
a set of participants;
an importance score;
a time range; and
activity-related information.

3. The method of claim 2, wherein the activity-related information includes at least one of:
location-related information;
transportation information;
a coupon;
an advertisement;
an item list indicating items for the user to bring to the scheduled activity;
an electronic document related to the scheduled activity;
information about other participants of the scheduled activity; and
itinerary-related information for the scheduled activity.

4. The method of claim 1, wherein generating the schedule modification includes at least one of:
deriving a new scheduled activity for the user;
rescheduling an existing scheduled activity;
adding a participant to an existing scheduled activity;
removing a participant from an existing scheduled activity;
modifying a location for an existing scheduled activity; and
modifying activity-related information associated with a scheduled activity.

5. The method of claim 1, wherein generating the schedule modification involves automatically deriving an activity for the user based on historical information associated with the user.

6. The method of claim 5, wherein automatically deriving the activity for the user involves:
comparing the schedule-modifying event to historical events associated with the user to identify one or more matching historical events;
determining, from the matching historical events, one or more target activities that the user has created or modified in response to the historical events; and
creating a scheduled activity for the user based on the one or more target activities.

7. The method of claim 6, wherein the target activity includes one or more of:
an activity that is periodically repeated by the user, and that is not in the user's set of scheduled activities;
an activity that is historically correlated to an activity in the user's set of scheduled activities; and
an activity that the user performs after an activity in the user's set of scheduled activities.

8. The method of claim 1, wherein rescheduling the set of scheduled activities involves:
generating one or more alternative schedules by processing the set of scheduled activities using one or more scheduling techniques;
processing a respective schedule using a utility function to compute a utility score for the respective schedule; and
selecting, from the alternative schedules, a schedule with a highest utility score.

9. The method of claim 8, wherein the utility function takes as input one or more of:
an importance score for a respective scheduled activity;
a time duration during the scheduled activities;
a time duration between scheduled activities;
a travel time duration;
a distance travelled between scheduled activities;
a cost associated with rescheduling a scheduled activity;
an activity deadline;
a cost for missing a deadline for a scheduled activity; and
a dependency between two or more scheduled activities.

10. The method of claim 1, further comprising:
responsive to generating the schedule modification:
presenting the schedule modification to the user;
receiving a response to the schedule modification from the user;
updating the schedule modification based on the response; and
storing a historical event that includes the schedule-modifying event in association with the updated schedule modification.

11. The method of claim 1, wherein the schedule-modifying event includes at least one of:
determining that the user is traveling to a predetermined location;
determining that the user has arrived at a predetermined location;
detecting a change in a weather forecast;
detecting a change in travel conditions;
detecting that a proximity between the user and another participant of a scheduled activity is within a predetermined threshold;
determining that the user has missed a scheduled activity;
determining that a new scheduled activity associated with the user has been created;
determining that a scheduled activity associated with the user has been modified;
determining that a scheduled activity associated with the user has been cancelled;
determining that a scheduled activity associated with the user was not conclusive;
determining that the user has performed an action that oftentimes precedes the user creating a new scheduled activity; and
automatically deriving a new activity for the user.

12. A non-transitory computer-readable storage medium storing instructions that when executed by a computer cause the computer to perform a method, the method comprising:
detecting a schedule-modifying event for a user, wherein the schedule-modifying event includes an event which is likely to require the user to modify a set of scheduled activities;
generating a schedule modification, which includes at least one change the user's set of scheduled activities, to account for the schedule-modifying event; and
rescheduling the user's set of scheduled activities to accommodate the schedule modification.

13. The storage medium of claim 12, wherein a scheduled activity includes at least one of:
a location;
a set of participants;
an importance score;
a time range; and
activity-related information.

14. The storage medium of claim 12, wherein generating the schedule modification includes at least one of:
deriving a new scheduled activity for the user;
rescheduling an existing scheduled activity;
adding a participant to an existing scheduled activity;
removing a participant from an existing scheduled activity;
modifying a location for an existing scheduled activity; and
modifying activity-related information associated with a scheduled activity.

15. The storage medium of claim 12, wherein generating the schedule modification involves:
comparing the schedule-modifying event to historical events associated with the user to identify one or more matching historical events;
determining, from the matching historical events, one or more target activities that the user has created or modified in response to the historical events; and
creating a scheduled activity based on the one or more target activities.

16. The storage medium of claim 12, wherein rescheduling the set of scheduled activities involves:
generating one or more alternative schedules by processing the set of scheduled activities using one or more scheduling techniques;
processing a respective schedule using a utility function to compute a utility score for the respective schedule; and
selecting, from the alternative schedules, a schedule with a highest utility score.

17. The storage medium of claim 16, wherein the utility function takes as input one or more of:
an importance score for a respective scheduled activity;
a time duration during the scheduled activities;
a time duration between scheduled activities;
a travel time duration;
a distance travelled between scheduled activities;
a cost associated with rescheduling a scheduled activity;
an activity deadline;
a cost for missing a deadline for a scheduled activity; and
a dependency between two or more scheduled activities.

18. The storage medium of claim 12, wherein the method further comprises:
responsive to generating the schedule modification:
presenting the schedule modification to the user;
receiving a response to the schedule modification from the user;
updating the schedule modification based on the response; and
storing a historical event that includes the schedule-modifying event in association with the updated schedule modification.

19. An apparatus, comprising:
an event-detection module to detect a schedule-modifying event for a user, wherein the schedule-modifying event includes an event which is likely to require the user to modify a set of scheduled activities;
an activity-managing module to generate a schedule modification, which includes at least one change the user's set of scheduled activities, to account for the schedule-modifying event; and
a schedule-modifying module to reschedule the user's set of scheduled activities to accommodate the schedule modification.

20. The apparatus of claim 19, wherein a scheduled activity includes at least one of:
a location;
a set of participants;
an importance score;
a time range; and
activity-related information.

21. The apparatus of claim 19, wherein while generating the schedule modification, the activity-managing module is configured to perform an operation one of:
deriving a new scheduled activity for the user;
rescheduling an existing scheduled activity;
adding a participant to an existing scheduled activity;
removing a participant from an existing scheduled activity;
modifying a location for an existing scheduled activity; and
modifying activity-related information associated with a scheduled activity.

22. The apparatus of claim 19, wherein while generating the schedule modification, the activity-managing module is configured to:
compare the schedule-modifying event to historical events associated with the user to identify one or more matching historical events;
determine, from the matching historical events, one or more target activities that the user has created or modified in response to the historical events; and
create a scheduled activity based on the one or more target activities.

23. The apparatus of claim 19, wherein while rescheduling the set of scheduled activities, the schedule-modifying module is configured to:
generate one or more alternative schedules by processing the set of scheduled activities using one or more scheduling techniques;
process a respective schedule using a utility function to compute a utility score for the respective schedule; and
select, from the alternative schedules, a schedule with a highest utility score.

24. The apparatus of claim 23, wherein the utility function takes as input at least one of:
an importance score for a respective scheduled activity;
a time duration during the scheduled activities;
a time duration between scheduled activities;
a travel time duration;
a distance travelled between scheduled activities;
a cost associated with rescheduling a scheduled activity;
an activity deadline;
a cost for missing a deadline for a scheduled activity; and
a dependency between two or more scheduled activities.

25. The apparatus of claim 19, further comprising a user-interface module, wherein responsive to the activity-managing module generating the schedule modification, the user-interface module is configured to:
present the schedule modification to the user; and
receive a response to the schedule modification from the user; and
wherein the activity-managing module is further configured to:
update the schedule modification based on the user's response; and
store a historical event that includes the schedule-modifying event in association with the updated schedule modification.
